(19) United States
(12) Patent Application Publication
(10) Pub. No.: US 2003/0021923 A1
(43) Pub. Date: Jan. 30, 2003

(54) Reusable inflatable zone packing pad

(76) Inventor: Thomas Louis Russo, Rutland, VT (US)

Correspondence Address: Thomas Louis Russo, 7 Avenue D, Rutland, VT, 05701, US

(21) Appl. No.: 09/911,949

(22) Filed: Jul. 24, 2001

(51) Int. Cl. B32B 1/02

(52) U.S. Cl. 428/35.2

(57) ABSTRACT

A reusable, inflatable zone packing pad comprised of multi-chambered pad formed of first and second outer film layers, and having two or four discrete inflatable zones, wherein each zone is further comprised of a plurality of inflatable chambers, preferably conical in shape. The multi-chamber design facilitates absorption of impact upon the pad by permitting redistribution of an inflation gas, e.g., air, from an area of impact to a non-impacted area within the same zone. The flow of inflation gas into and/or out of the pad is controlled by an entry/exit passageway tube for each separate zone.

### FIELD OF THE INVENTION

The invention is directed to impact-resistant packing pads for protecting articles during shipping from shock and damage and, more particularly, to a reusable, inflatable multi-zone packing pad that provides a higher fill volume profile, provided with and air entry portal adapted for permitting independent inflation/deflation of said zones.

### BACKGROUND OF THE INVENTION

When articles are packaged in a container for shipping, void spaces are typically created between the article and the inner surface of the container. Packaged articles come in a variety of shapes, thus producing a plurality of irregularly shaped voids. A packing material is thus commonly inserted within these voids to cushion and protect the packaged article during shipping.

It is known, therefore, to at least partially surround shipped articles with packing materials having a variety of shapes and sizes such as Styrofoam® “chips,” injected Styrofoam® moldings, “bubble” mats and other energy absorptive materials. “Bubble” mats, are intended to wrap close to the shipped item providing an enclosure that protects the item, but the spaces between the “bubble” mat protected item and the interior surfaces of the container are largely filled with a volume of a loose fill type material Styrofoam® “chips,” and other particulate packing materials provide a loose fill and the packaged article may settle during transport, reducing the cushioning effect. Moreover all of the above-described packing materials are themselves voluminous to both ship and store. In addition, they could create waste disposed problems with attendant problems of environmental degradation.

In an effort to overcome the problems noted above, various forms of inflated cushions have been utilized. Such cushions are well known and have been commonly used for some time in the shipment of goods. Several useful examples of inflatable cushions are illustrated in, for example, U.S. Pat. Nos. 5,427,830; 5,447,235 and 5,487,470 to David A. Pharo. The inflatable packaging systems described therein, and throughout the prior art have been faced with a number of design challenges, however.

For example, some of the inflatable cushions include only a single inflatable zone, such that a failure at any location in the packaging material will lead to a total deflation of the system, thus resulting in a total loss of function. Other examples include cushions with a plurality of interconnected inflatable zones, i.e., providing, a “quilted” appearance to the cushion. This arrangement still remains prone, however, to the deflation problem described above. Still other embodiments comprise a plurality of discrete, i.e., separate, chambers, which do not, as is desirable, permit redistribution of air within the pad, i.e., from one chamber to another, upon impact to the outer surface of one or more such chambers. Additionally, many such prior art inflatable packing systems are further subject to other problems, as described below, caused due to the use of valve systems that may channel air under impact pressure directly toward the valve cap forcing open the valve, or self-sealing valves that are most effective when cushions maintain a consistent pressure once inflated, this consistent pressure provides a back pressure helping to make the valve self-sealing. Thus, the dimensions of these inflatable cushions may find it difficult to adjust to different sized voids within a packing container. Still further, due to the very nature of the self-sealing valves such inflatable devices are typically not readily reusable since it is difficult, if not impossible, to empty the air out of an inflated cushion or pad without reducing the useful life of each cushion, i.e. puncturing the cushion or disrupting the self-sealing properties.

It is thus readily apparent that there exists a long-felt need, which is satisfied by the present invention as described herein, for a reliable, efficient, adjustably inflatable protective packaging pad, with multiple zones and a higher volume profile, for protecting fragile and/or valuable items during shipping. The present invention meets these requirements with a simple design that is readily and conveniently manufactured from inexpensive starting materials. It may be used, and reused, for an unlimited variety of shapes and sizes of product being packaged. The protective inflatable pad that is self-adapting to the size and shape of the item being packaged, which will not settle during shipment, and that will secure itself around the object to be shipped while substantially filling all of the void spaces between the object and the outer container. The object of the invention is thus relatively simple to ship and store and it is cost competitive with presently existing systems.

### SUMMARY OF THE INVENTION

It is therefore an object of the invention to provide an inflatable, reusable packing pad formed with at least two separately inflatable and deflatable zones, and further wherein each said zone is comprised of a plurality of interconnected air chambers adapted to facilitate absorption of impact to the pad and to redistribute air from chambers compressed by the impact to alternate air chambers located within each corresponding zone.

It is another object of the invention to provide chambers with a conical shape or configuration such that, maximum inflated pad height can be achieved in a zone format, by balancing these conical chambers it is possible to provide security in the event one air chamber is punctured in that adjacent unaffected (i.e., unpunctured) zones will assist in maintaining the inflated height of the pad upon such an event due to crossing-over of zones provided by zone layout.

It is another object of the invention to provide an inflatable, reusable packing pad wherein the flow of air into the pad is controlled by at least one zoned entry/exit portal which, due to its design and construction, allows this portal to withstand a significant air pressure caused due to impact, i.e., causing compression, upon one of the inflated zones of the pad, without forcing the portal open.

These and other objects of the invention are achieved through the use of an inflatable, reusable packing pad as described and illustrated herein.

In a first embodiment the invention is directed to a two zone packing pad which, zones can be aligned side by side comprising a two zone entry/exit portal tube. Zones can also be aligned top and bottom, and right and left sides wherein each said zone directs impacted air pressure through the central core of the pad layout, also utilizing a two zone entry/exit portal tube. In a further embodiment, the packing pad of the invention comprises a four zone packing pad utilizing a four zone entry/exit portal tube wherein each said zone controls the flow of air into and out of a separate said zone. The four zone pad offers additional protection from accidental deflation throughout the shipping process.

The system of invention was designed with multiple zones, each formed with multiple air chambers, in a single packing pad to allow each pad the ability to absorb impact by distributing air to chambers not compressed by impact. That is, the pad comprises at least two inflation zones, and each said zone may be further broken down into a plurality of inflatable chambers. The packing pad of the invention can be manufactured in a variety of shapes and sizes, and from a variety of materials as well. FIG. 1, FIG. 15 and FIG. 12, FIG. 25, illustrating, respectively, a two zone and a four zone pad, FIG. 1 and FIG. 15, display an exemplary geometric design for the pad chambers wherein said chambers are conical shaped and use the maximum film surface, providing a high volume profile with added zoned format security. The invention is not limited, however, to the particular arrangement portrayed in the subject drawing figures. That is, whereas a conical configuration is preferred, the chambers of the pad of the invention are not limited to a conical shape and may, instead, be configured in a variety of alternate shapes. In the illustrated embodiment, the pad fill height can be increased by making the conical chambers larger. Pads can also be made longer and shorter by adding or subtracting cones from a design layout. This flexibility of design thus provides a custom system useful for a variety of applications, while still offering the same degree of zone security.

The ability to be inflated or deflated (see, e.g., FIG. 1 and FIG. 11, FIG. 15 and FIG. 24) as the task requires, provides a reusable packing pad for all users in the shipping cycle. The packing pad of the invention can be stored deflated when not in use, thus reducing storage space requirements.

The system of the invention, comprising a packing pad with at least one, zoned entry/exit portal, is inflated and deflated through the use of the zoned entry/exit portal tube and requires no special equipment to operate. The pads can be filled by mouth or with compressed air, allowing the end user to store, reuse and recycle this packing fill.

Security against unintended deflation is thus provided through zone design and the entry/exit portal tube tuck-away as further described herein.

The packing pad of the invention may, moreover, be printed with a company logo or other graphics inside and out, thus allowing packing fill to be a marketing image piece.

### BRIEF DESCRIPTION OF THE DRAWINGS

The foregoing objects and other advantages of the present invention will be more fully understood from the following detailed description and reference to the appended drawings, wherein:

FIG. 1 is a top plan view of the side by side two zoned packing pad

FIG. 2 is a perspective view of a side by side two zoned packing pad.

FIG. 3 is a component view of the side by side two-zoned packing pad, illustrating relationship between the A and B film entry/exit portal tube and zone conical air chamber layout.

FIG. 4 is a perspective view of an inflated side by side two zoned packing pad, illustrating the inflated entry/exit portal tube and the interior zone layout.

FIG. 5 is a perspective view of an inflated side by side two zoned packing pad,

FIG. 6 is a perspective close-up view of an inflated side by side two zoned packing pad, illustrating the inflated entry/exit portal tube

FIG. 7 is a close-up front view of an inflated side by side two zoned packing pad, illustrating the inflated entry/exit portal tube

FIG. 8 is a close-up front view of the side by side two-zoned packing pad, illustrating the inflated entry/exit portal tube with the first closing fold.

FIG. 9 is a close-up front view of the side by side two-zoned packing pad, illustrating the inflated entry/exit portal tube with the second closing fold.

FIG. 10 is a close-up front view of side by side two-zoned packing pad, illustrating the inflated entry/exit portal tube in the tuck-away position.

FIG. 11 is a perspective view of an inflated side by side two zoned packing pad, illustrating the closed tuck-away position of the entry/exit portal tube.

FIG. 12 is a component view of the side by side four-zoned packing pad, illustrating relationship between the A and B film entry/exit portal tube and zone conical air chamber layout and the center C film that creates the four zones.

FIG. 13 is a top plan view of the side by side two-zoned or four-zoned packing pad, illustrating layout orientation of two separate pads in a production layout

FIG. 14 is a top plan view of the side by side two-zoned or four-zoned packing pad, illustrating layout orientation of two separate pads and additional similar arranged pads in a production layout to accommodate rolled or sheet film raw material.

FIG. 15 is a top plan view of the top to bottom and side to side two zoned packing pad

FIG. 16 is a perspective view of a top to bottom and side to side two zoned packing pad.

FIG. 17 is a component view of the top to bottom and side to side two-zoned packing pad, illustrating relationship between the A and B film entry/exit portal tube, central core film and zone conical air chamber layout.

FIG. 18 is a top perspective view of the top to bottom and side to side two zoned packing pad central core film, illustrating the heat-weld seams in the A film that create air passage to the zone two air chambers.

FIG. 19 is a through perspective view of the top to bottom and side to side two zoned packing pad central core film, illustrating the heat-weld seams in the B film that create air passage to the zone one air chambers and their relationship to zone two air passageway.

FIG. 20 is a through perspective view of the top to bottom and side to side two zoned packing pad with A and B films connected only at the central core film, illustrating the B film air passage for zone one air chambers and the A film air passageway for zone two air chambers

FIG. 21 is a completed sealed perspective view of FIG. 20, illustrating the relationship of zone one and two air chambers and the central core film.

FIG. 22 is a perspective view of an inflated top to bottom and side to side two zoned packing pad, illustrating an open entry/exit portal tube.

FIG. 23 is a close-up view of an inflated top to bottom and side to side two zoned packing pad, illustrating an open entry/exit portal tube.

FIG. 24 is a perspective view of an inflated top to bottom and side to side two zoned packing pad, illustrating the closed position of the entry/exit portal tube in the tuck-away pocket.

FIG. 25 is a component view of the top to bottom and side to side four-zoned packing pad, illustrating relationship between the A and B film entry/exit portal tube, first and second central core film and zone conical air chamber layout and the center C film that creates the four zones.

### DETAILED DESCRIPTION OF THE INVENTION

The invention is therefore directed to an inflatable and reusable multi-zone packing pad wherein inflation and deflation of each said zone is independently controlled by and entry/exit portal comprised of a entry/exit portal tube and portal tube tuck-away, and further wherein each said zone is comprised of a plurality of, preferably cone-shaped, chambers configured and adapted to help absorb an impact thereupon and, upon such impact, to redistribute air within the pad from a compressed chamber to a non-compressed chamber, for improving the reliability of the pad.

Turning now to a description of the components illustrated in the drawing figures, which is thereafter followed by a discussion of how these various components work together in the invention,

FIG. 1 illustrates top plan view of a side by side two zone pad first conical air chamber of zone one (1), zone one passageway (2), connecting air chamber one (1) and conical air chamber two (3) In zone one. First conical air chamber of zone two (7), zone two passageway (6), connecting air chamber one (7) and conical air chamber two (5) In zone two. Entry/exit Portal Tube (12), controlling airflow into and out of the pad. Zone one entry/exit passageway (14), allowing air movement through zone one portal (9). Zone two entry/exit passageway (13), allowing air movement through zone two portal (10). Tuck-away (8), creating a pocket to secure the closed entry/exit Portal Tube (12). Extra wide heat welded outer seam (4), seam reduction at entry/exit portal tube (11).

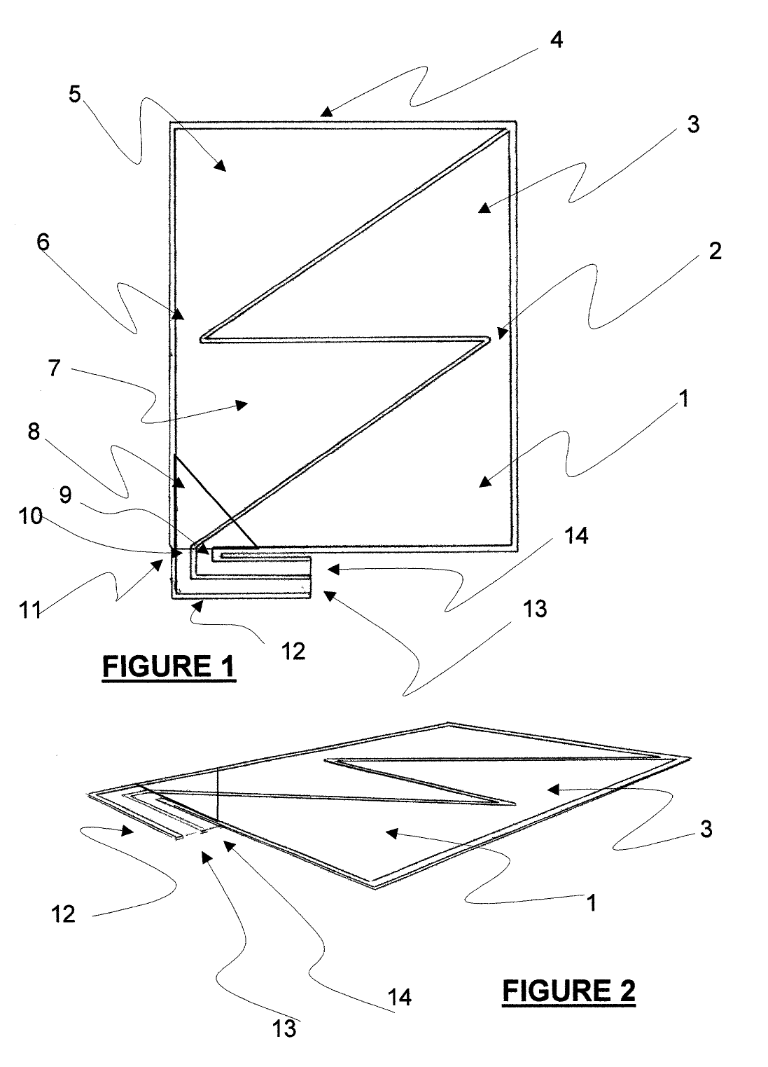

FIG. 2 illustrates perspective view of a side by side two zone pad first conical air chamber of zone one (1), zone one passageway FIG. 1 (2), connecting air chamber one (1) and conical air chamber two (3) In zone one. Entry/exit Portal Tube (12), controlling air flow into and out of the pad. Zone one entry/exit passageway (14), allowing air movement through zone one portal FIG. 1(9). Zone two entry/exit passageway (13), allowing air movement through zone two portal FIG. 1(10).

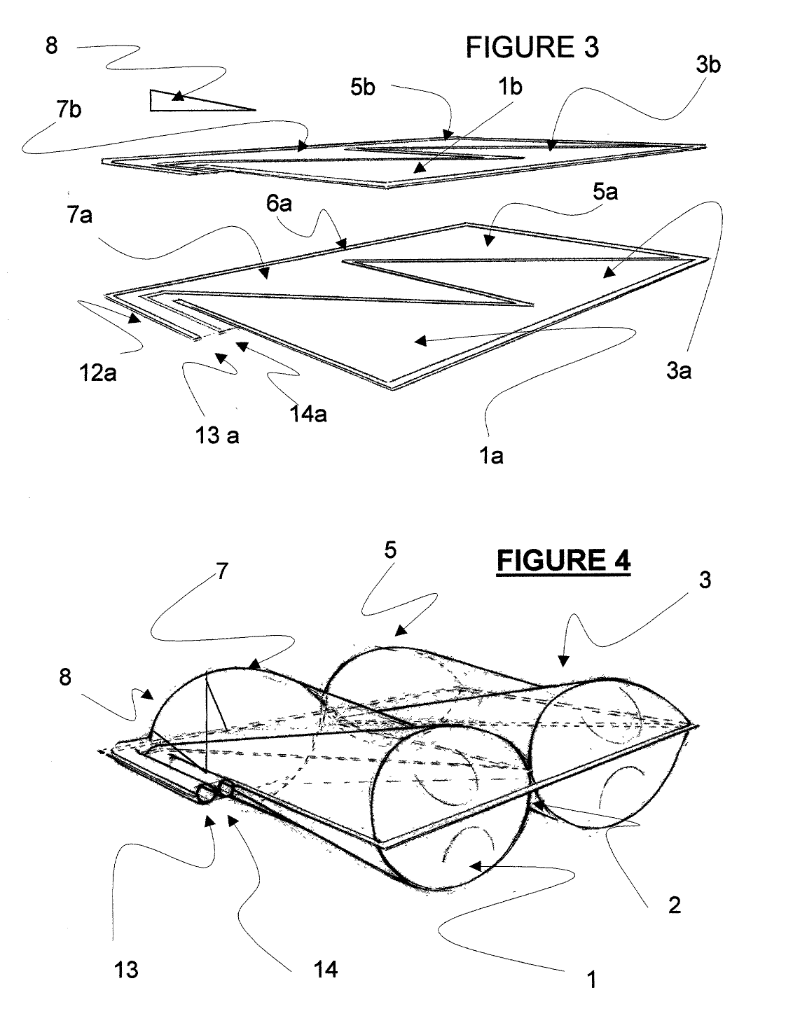

FIG. 3 illustrates component view of a side by side two zone pad, with A and B film layouts. first conical air chamber of zone one layout on film A (1a), zone one passageway FIG. 1 (2), connecting air chamber one layout in film A (1a) and conical air chamber two layout on film A (3a) In zone one. First conical air chamber layout on film A of zone two (7a), zone two passageway layout on film A (6a), connecting air chamber one layout on film A (7a) and conical air chamber two layout on film A (5a) In zone two. Entry/exit Portal Tube layout on film A (12a), controlling air flow into and out of the pad. Zone one entry/exit passageway layout on film A (14a), allowing air movement through zone one portal FIG. 1 (9). Zone two entry/exit passageway layout on film A (13a), allowing air movement through zone two portal FIG. 1 (10). Tuck-away (8), creating a pocket to secure the closed entry/exit Portal Tube FIG. 1 (12). first conical air chamber of zone one layout on film B (1b), zone one passageway FIG. 1 (2), connecting air chamber one layout in film B (1b) and conical air chamber two layout on film B (3b) In zone one. First conical air chamber layout on film B of zone two (7b), zone two passageway layout on film B (6b), connecting air chamber one layout on film B (7b) and conical air chamber two layout on film B (5b) In zone two.

FIG. 4 illustrates perspective view of inflated side by side two zone pad first conical air chamber of zone one (1), zone one passageway (2), connecting air chamber one (1) and conical air chamber two (3) In zone one. First conical air chamber of zone two (7), zone two passageway (6), connecting air chamber one (7) and conical air chamber two (5) In zone two. Entry/exit Portal Tube FIG. 1(12), controlling airflow into and out of the pad. Zone one entry/exit passageway (14), allowing air movement through zone one portal FIG. 1(9). Zone two entry/exit passageway (13), allowing air movement through zone two portal FIG. 1 (10). Tuck-away (8), creating a pocket to secure the closed entry/exit Portal Tube (12).

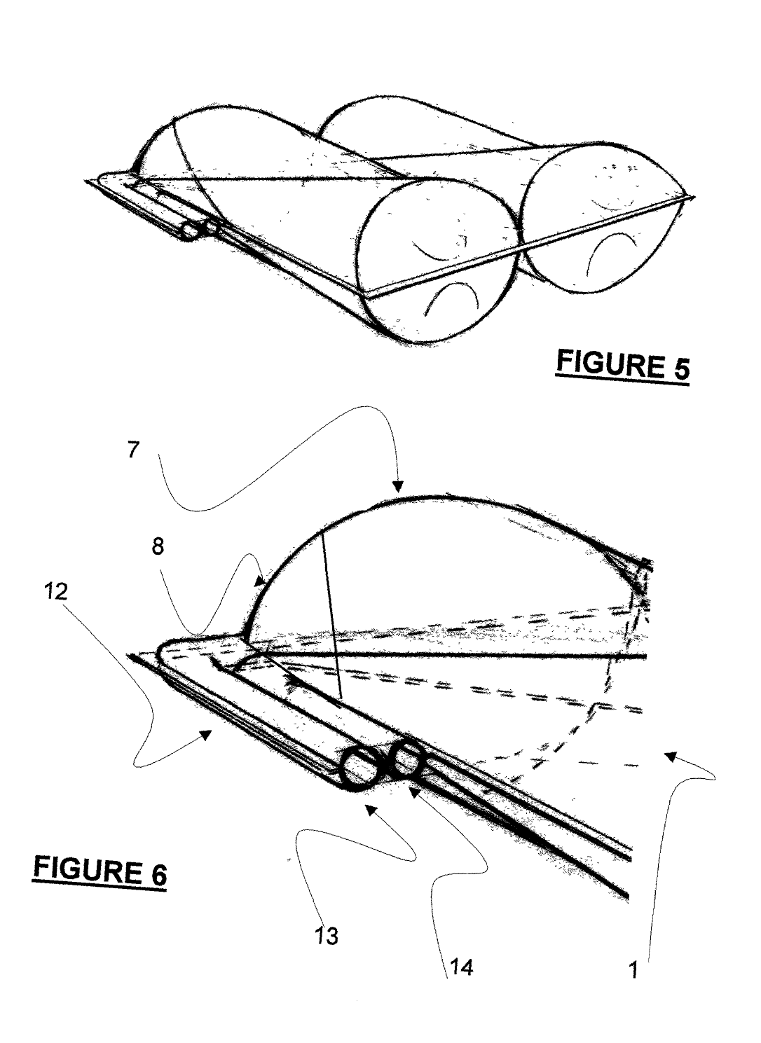

FIG. 5 illustrates perspective view of inflated side by side two zone pad with the entry/exit portal tube in the open position

FIG. 6 is a perspective close-up view of an inflated side by side two zoned packing pad, illustrating the inflated entry/exit portal tube, first conical air chamber of zone one (1), First conical air chamber of zone two (7), Tuck-away (8), Entry/exit Portal Tube (12), controlling airflow into and out of the pad. Zone one entry/exit passageway (14), allowing air movement through zone one portal FIG. 1(9). Zone two entry/exit passageway (13), allowing air movement through zone two portal FIG. 1 (10).

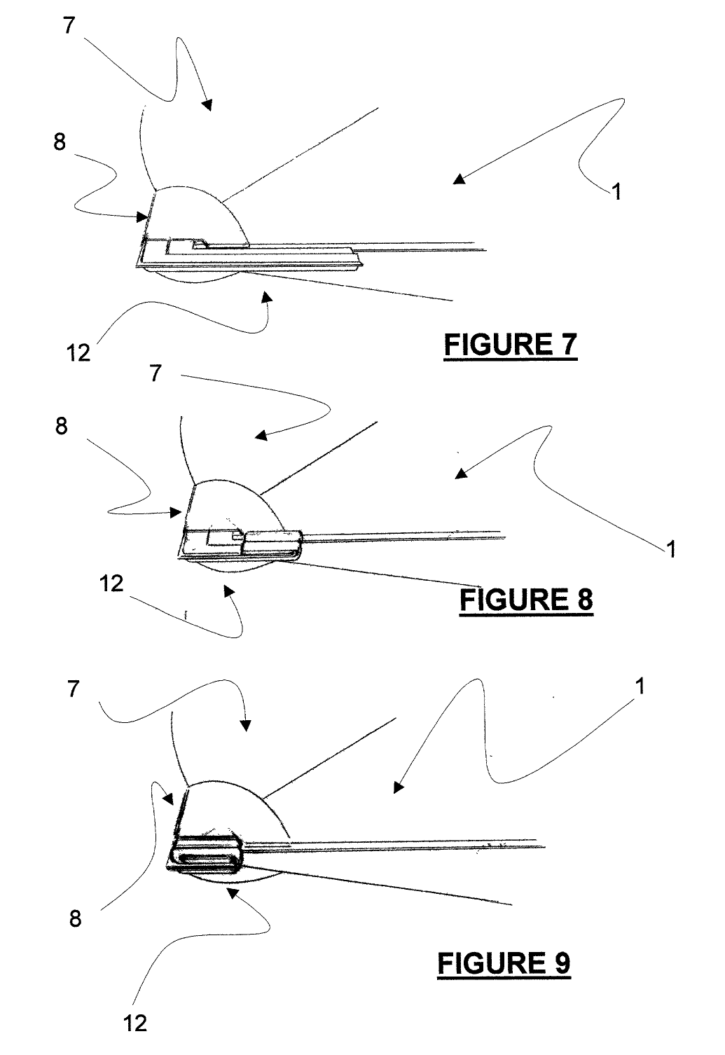

FIG. 7 is a close-up front view of an inflated side by side two zoned packing pad, illustrating the inflated entry/exit portal tube (12), first conical air chamber of zone one (1), First conical air chamber of zone two (7), Tuck-away (8)

FIG. 8 is a close-up front view of the side by side two-zoned packing pad, illustrating the inflated entry/exit portal tube (12), with the first closing fold. first conical air chamber of zone one (1), First conical air chamber of zone two (7), Tuck-away (8)

FIG. 9 is a close-up front view of the side by side two-zoned packing pad, illustrating the inflated entry/exit portal tube (12), with the second closing fold. first conical air chamber of zone one (1), First conical air chamber of zone two (7), Tuck-away (8)

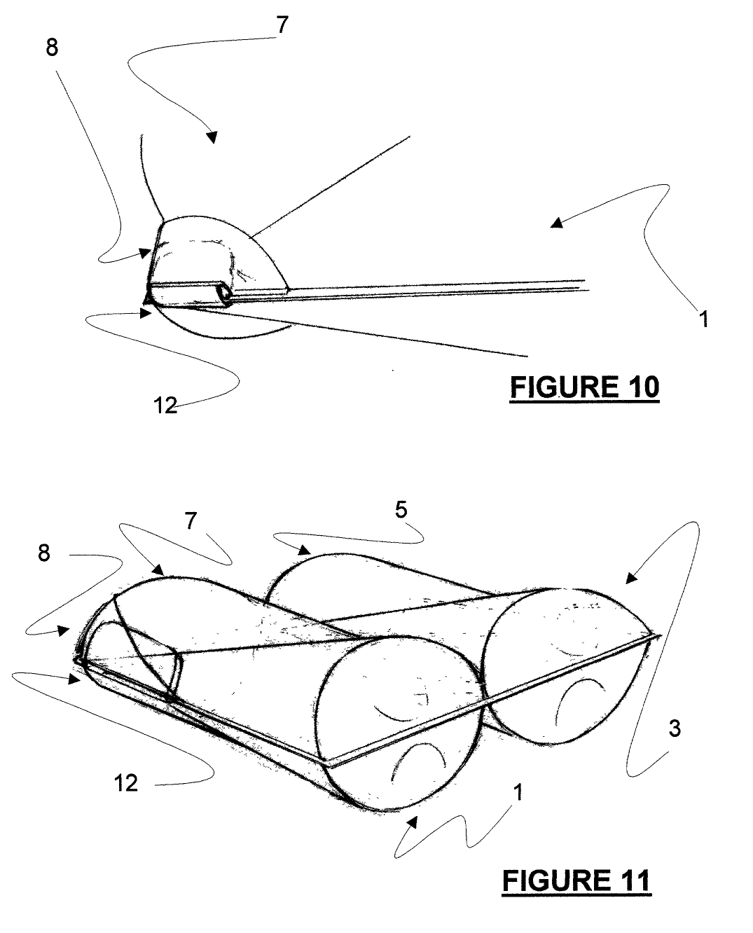

FIG. 10 is a close-up front view of side by side two-zoned packing pad, illustrating the inflated entry/exit portal tube (12), in the tuck-away position. first conical air chamber of zone one (1), First conical air chamber of zone two (7), Tuck-away (8)

FIG. 11 is a perspective view of an inflated side by side two zoned packing pad, illustrating the closed tuck-away position of the entry/exit portal tube (12), first conical air chamber of zone one (1), zone one passageway FIG. 1 (2), connecting air chamber one (1) and conical air chamber two (3) In zone one. First conical air chamber of zone two (7), zone two passageway FIG. 1(6), connecting air chamber one (7) and conical air chamber two (5) In zone two. Entry/exit Portal Tube (12), controlling airflow into and out of the pad. Zone one entry/exit passageway FIG. 1 (14), allowing air movement through zone one portal FIG. 1(9) Zone two entry/exit passageway FIG. 1(13), allowing air movement through zone two portal FIG. 1 (10). Tuck-away (8), creating a pocket to secure the closed entry/exit Portal Tube (12).

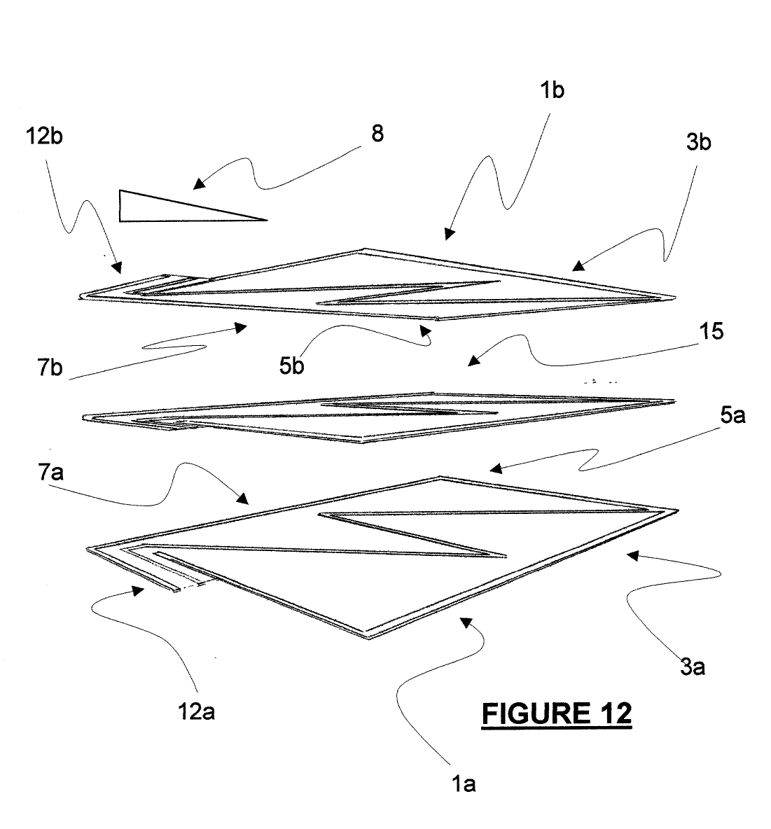

FIG. 12 illustrates component view of a side by side four zone pad, with A and B film layouts and the third film C (15), that divides the pad in half creating the four zones, the first zone is divided into zones one and three, and the second zone is divided into zones two and four. First conical air chamber of zone one layout on film A (1a), zone one passageway FIG. 1 (2), connecting air chamber one layout in film A (1a) and conical air chamber two layout on film A (3a) In zone one, film C (15) divide this zone in half allowing film A and film B to create zones one and three. First conical air chamber layout on film A of zone two (7a), zone two passageway layout on film A (6a), connecting air chamber one layout on film A (7a) and conical air chamber two layout on film A (5a) In zone two, film C (15) divide this zone in half allowing film A and film B to create zones two and four. Entry/exit Portal Tube layout on film A (12a), controlling air flow into and out of the pad. Zone one entry/exit passageway layout on film A (14a), allowing air movement through zone one portal FIG. 1 (9). Zone two entry/exit passageway layout on film A (13a), allowing air movement through zone two portal FIG. 1 (10), film C (15) divides the portal tube into four entry/exit tubes supporting four zones. Tuck-away (8), creating a pocket to secure the closed entry/exit Portal Tube FIG. 1 (12). first conical air chamber of zone one layout on film B (1b), zone one passageway FIG. 1 (2), connecting air chamber one layout in film B (1b) and conical air chamber two layout on film B (3b) In zone one, film C (15) divide this zone in half allowing film A and film B to create zones one and three. First conical air chamber layout on film B of zone two (7b), zone two passageway layout on film B (6b), connecting air chamber one layout on film B (7b) and conical air chamber two layout on film B (5b) In zone two, film C (15) divide this zone in half allowing film A and film B to create zones two and four.

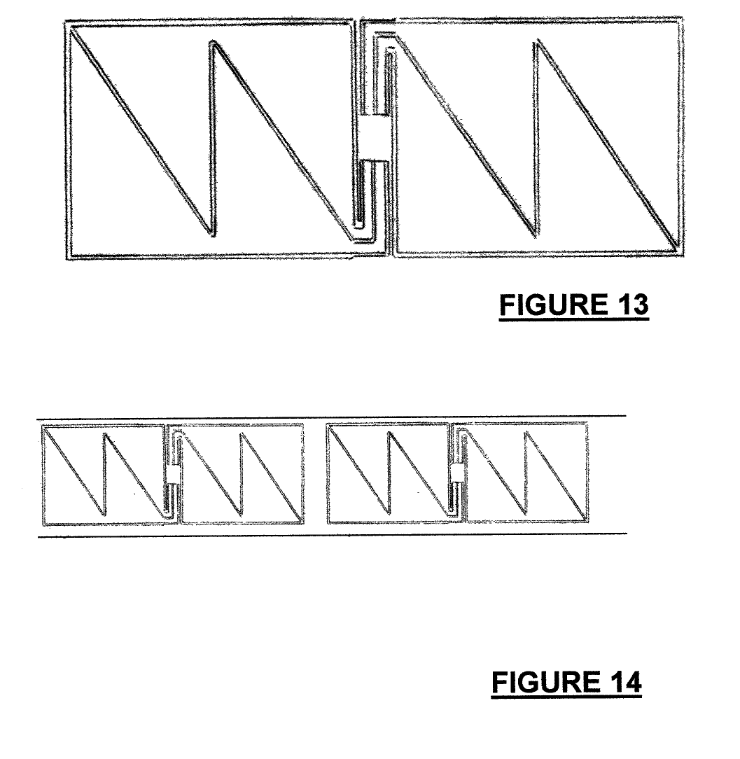

FIG. 13 is a top plan view of the side by side two-zoned or four-zoned packing pad, illustrating layout orientation of two separate pads in a production layout Pads are arranged to create a production pair improving raw material film usage.

FIG. 14 is a top plan view of the side by side two-zoned or four-zoned packing pad, illustrating layout orientation of two separate pads and additional similar arranged pads in a production layout to accommodate rolled or sheet film raw material. Production pairs can be rolled or stamped out of film rolls or film sheets for efficient production.

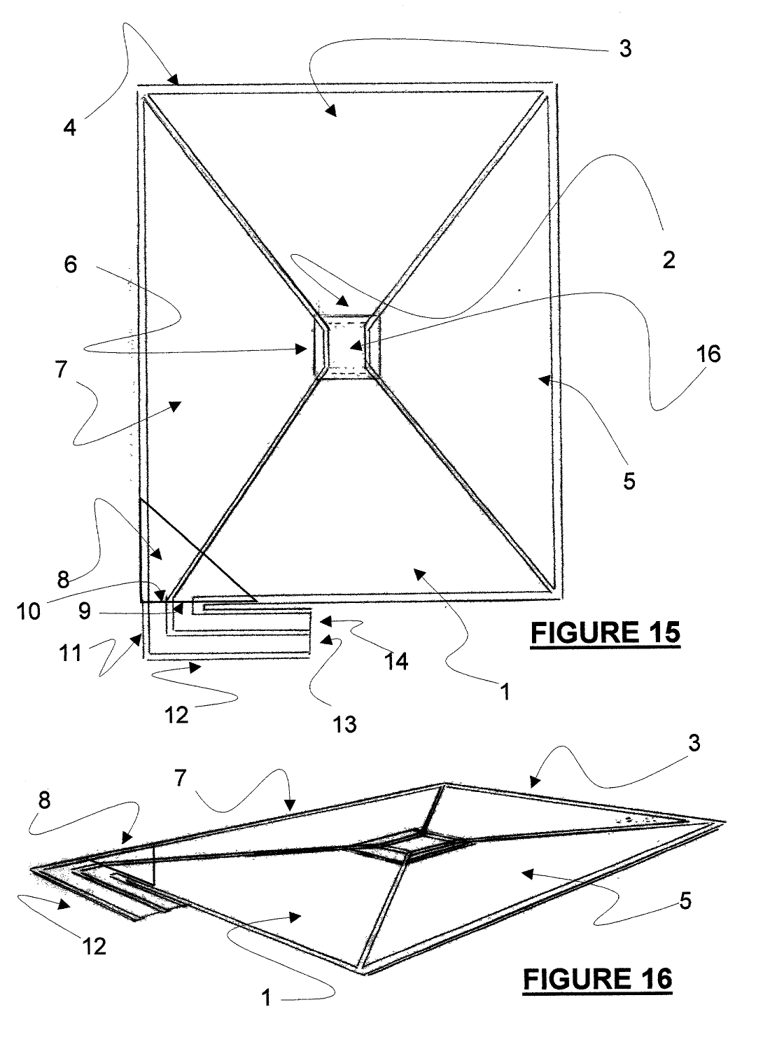

FIG. 15 illustrates top plan view of a top to bottom and side to side two zone pad first conical air chamber of zone one (1), zone one passageway (2), connecting air chamber one (1) and conical air chamber two (3) In zone one. First conical air chamber of zone two (7), zone two passageway (6), connecting air chamber one (7) and conical air chamber two (5) In zone two. Entry/exit Portal Tube (12), controlling airflow into and out of the pad. Zone one entry/exit passageway (14), allowing air movement through zone one portal (9). Zone two entry/exit passageway (13), allowing air movement through zone two portal (10). Tuck-away (8), creating a pocket to secure the closed entry/exit Portal Tube (12). Extra wide heat welded outer seam (4), seam reduction at entry/exit portal tube (11). Central core film (16), that creates the passageway (2), for zone one air chambers and passageway (6), for zone two air chambers.

FIG. 16 illustrates perspective view of a top to bottom and side to side two zone pad first conical air chamber of zone one (1), zone one passageway FIG. 15 (2), connecting air chamber one (1) and conical air chamber two (3) In zone one. Entry/exit Portal Tube (12), controlling air flow into and out of the pad. Zone one entry/exit passageway FIG. 15 (14), allowing air movement through zone one portal FIG. 15 (9). Zone two entry/exit passageway FIG. 15 (13), allowing air movement through zone two portal FIG. 15 (10). Tuck-away (8), creating a pocket to secure the closed entry/exit Portal Tube (12).

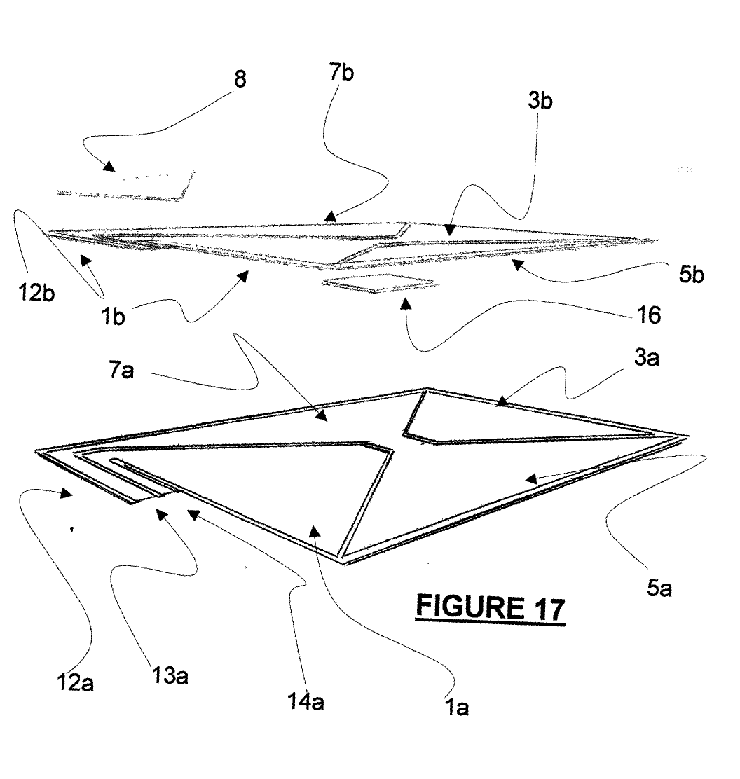

FIG. 17 is a component view of the top to bottom and side to side two-zoned packing pad, illustrating relationship between the A film, B film and central core film (16), first conical air chamber of zone one layout on film A (1a), zone one passageway FIG. 15 (2), connecting air chamber one layout in film A (1a) and conical air chamber two layout on film A (3a) In zone one. First conical air chamber layout on film A of zone two (7a), zone two passageway layout on film A (6a), connecting air chamber one layout on film A (7a) and conical air chamber two layout on film A (5a) In zone two. Entry/exit Portal Tube layout on film A (12a), controlling air flow into and out of the pad. Zone one entry/exit passageway layout on film A (14a), allowing air movement through zone one portal FIG. 15 (9). Zone two entry/exit passageway layout on film A (13a), allowing air movement through zone two portal FIG. 1 (10). Tuck-away (8), creating a pocket to secure the closed entry/exit Portal Tube FIG. 15 (12). first conical air chamber of zone one layout on film B (1b), zone one passageway FIG. 15 (2), connecting air chamber one layout in film B (1b) and conical air chamber two layout on film B (3b) In zone one. First conical air chamber layout on film B of zone two (7b), zone two passageway layout on film B (6b), connecting air chamber one layout on film B (7b) and conical air chamber two layout on film B (5b) In zone two. Central core film (16), that creates the passageway FIG. 15 (2), for zone one air chambers and passageway FIG. 15 (6), for zone two air chambers.

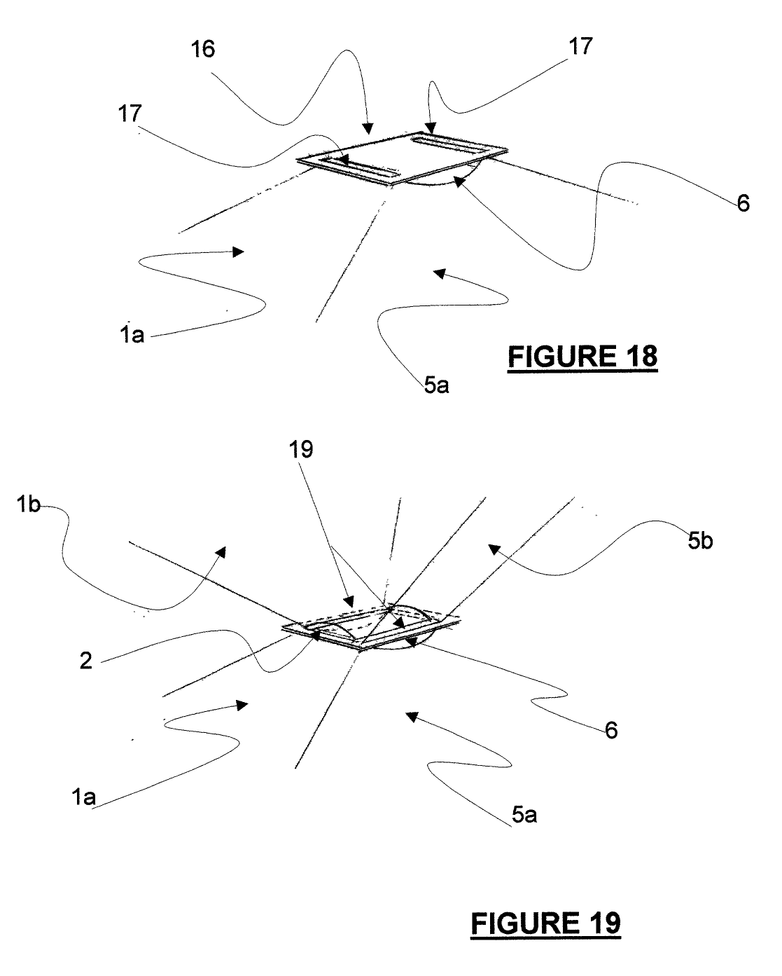

FIG. 18 is a top perspective view of the top to bottom and side to side two zoned packing pad central core film FIG. 15 (16), illustrating the heat-weld seams (17), in the A film that create air passageway (6) for the zone two air chambers FIG. 15 (7) (5). Reference FIG. 17 (1a) and (5A) for film positions.

FIG. 19 is a through perspective view of the top to bottom and side to side two zoned packing pad central core film FIG. 15 (16), illustrating the heat-weld seams (19),in the B film that create air passageway (2), for the zone one air chambers FIG. 15 (1) (3), and their relationship to zone two air passageway (6). Reference FIG. 17 (1a),(5a),(1b),(5b) for film positions.

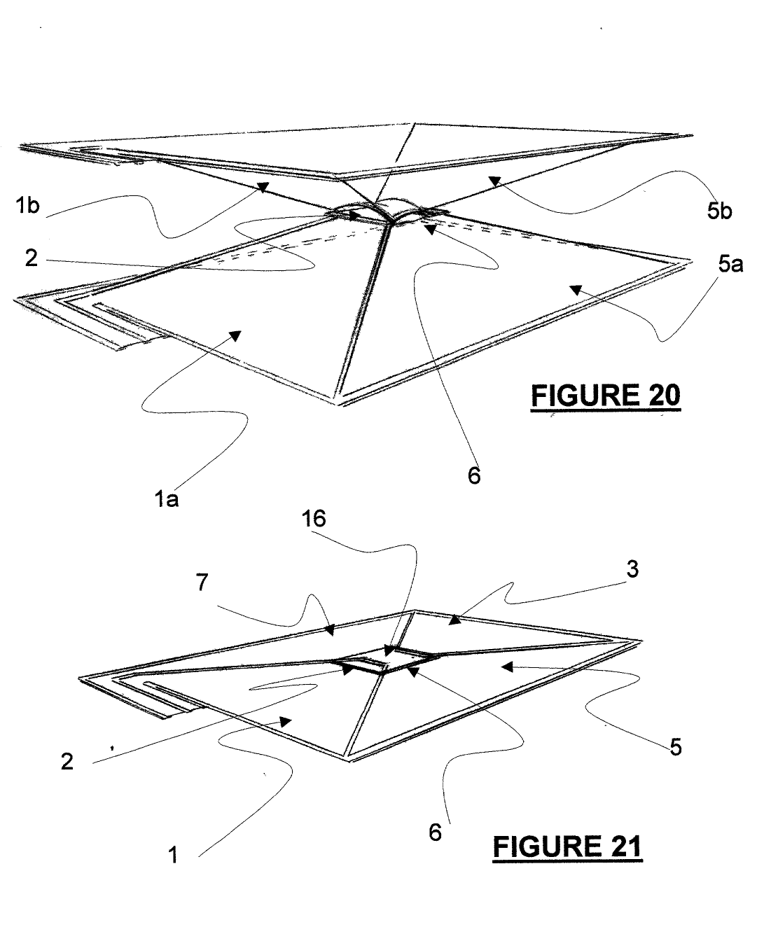

FIG. 20 is a through perspective view of the top to bottom and side to side two zoned packing pad with A and B films connected only at the central core film FIG. 17 (16), illustrating the B film air passageway (2), created by heat welds FIG. 19 (19), for zone one air chambers FIG. 15 (1) (3), and the A film air passageway (6), created by heat weld FIG. 18 (17), for zone two air chambers FIG. 15 (7) (5). Reference FIG. 17 (1a),(5a),(1b),(5b) for film positions.

FIG. 21 is a completed sealed perspective view of FIG. 20, illustrating the relationship of zone one and two air chambers and the central core film (16), first conical air chamber of zone one (1), zone one passageway (2), connecting air chamber one (1) and conical air chamber two (3) In zone one. First conical air chamber of zone two (7), zone two passageway (6), connecting air chamber one (7) and conical air chamber two (5) In zone two. Entry/exit Portal Tube FIG. 15 (12), controlling airflow into and out of the pad. Central core film (16) that creates the passageway (2), for zone one air chambers and passageway (6), for zone two air chambers.

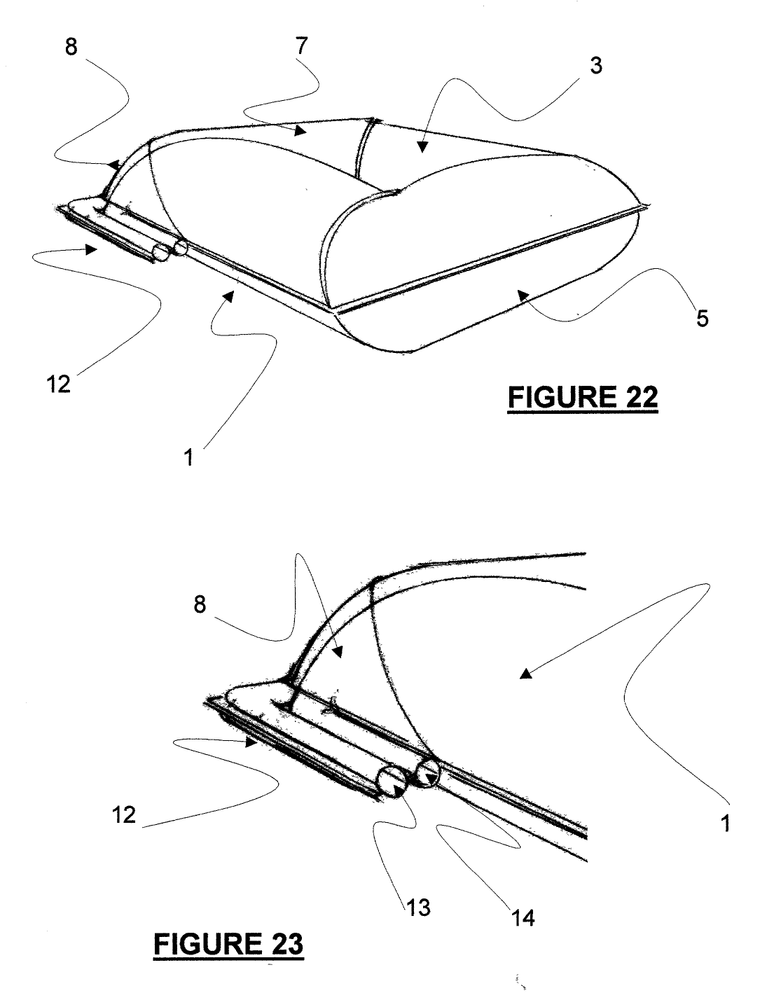

FIG. 22 is a perspective view of an inflated top to bottom and side to side two zoned packing pad, illustrating an open entry/exit portal tube (12). first conical air chamber of zone one (1), zone one passageway FIG. 15 (2), connecting air chamber one (1) and conical air chamber two (3) In zone one. First conical air chamber of zone two (7), zone two passageway FIG. 15 (6), connecting air chamber one (7) and conical air chamber two (5) In zone two. Entry/exit Portal Tube (12), controlling airflow into and out of the pad. Zone one entry/exit passageway FIG. 15(14), allowing air movement through zone one portal FIG. 15 (9). Zone two entry/exit passageway (13), allowing air movement through zone two portal FIG. 15 (10). Tuck-away (8), creating a pocket to secure the closed entry/exit Portal Tube (12).

FIG. 23 is a close-up view of an inflated top to bottom and side to side two zoned packing pad FIG. 22, illustrating an open entry/exit portal tube (12).

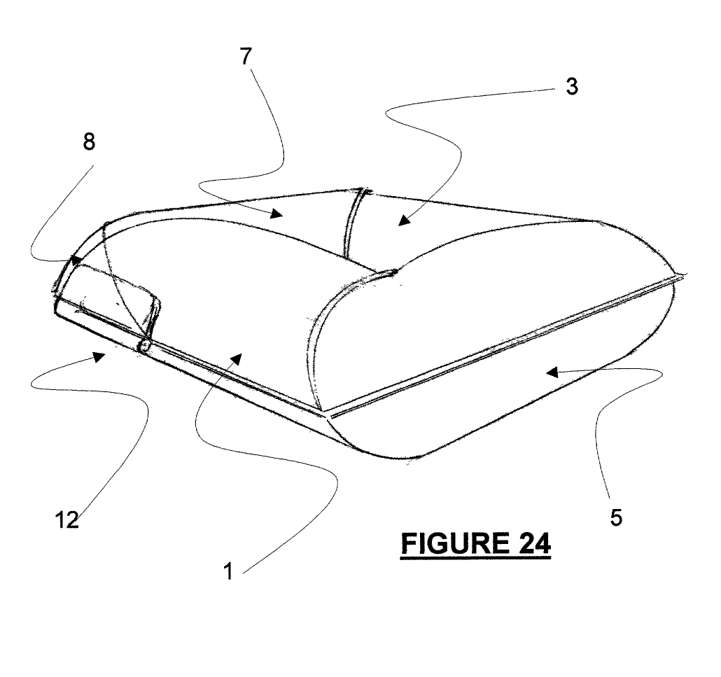

FIG. 24 is a perspective view of an inflated top to bottom and side to side two zoned packing pad, illustrating the closed position of the entry/exit portal tube (12), in the tuck-away pocket (8). first conical air chamber of zone one (1), zone one passageway FIG. 15 (2), connecting air chamber one (1) and conical air chamber two (3) In zone one. First conical air chamber of zone two (7), zone two passageway FIG. 15 (6), connecting air chamber one (7) and conical air chamber two (5) In zone two. Entry/exit Portal Tube (12), controlling airflow into and out of the pad in the closed tuck-away position.

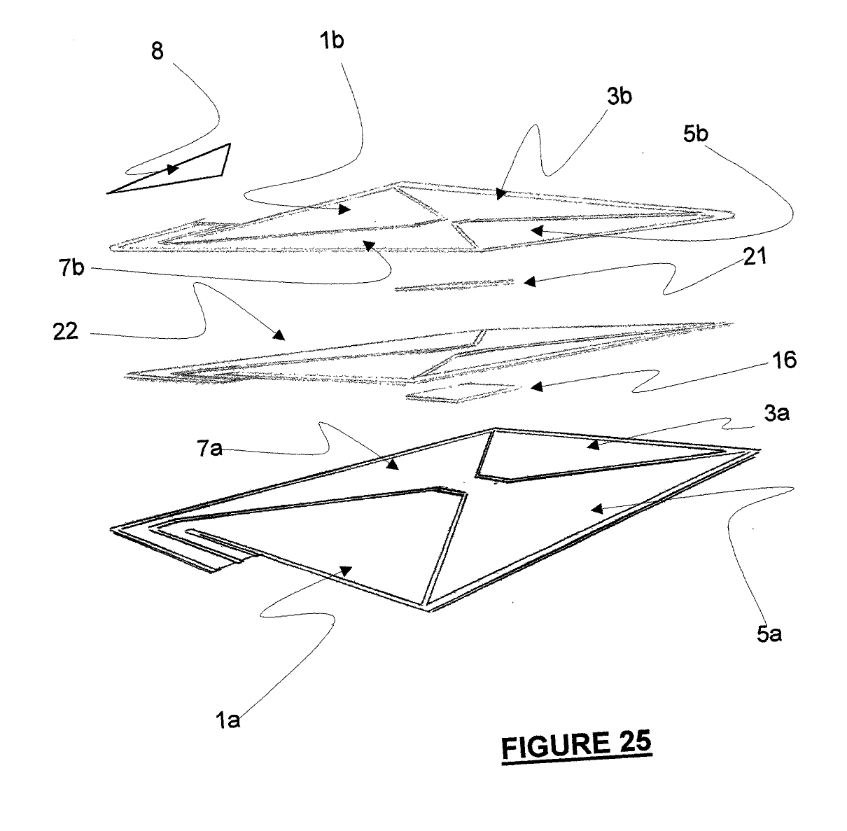

FIG. 25 is a component view of the top to bottom and side to side four-zoned packing pad, illustrating relationship between the A and B film entry/exit portal tube (12), first and second central core film (16), (21), and the center C film (22) that creates the four zones, separating zone one into zones one and three, and separating zone two into zone two and four. First conical air chamber of zone one layout on film A (1a), zone one passageway FIG. 15 (2), connecting air chamber one layout in film A (1a) and conical air chamber two layout on film A (3a) In zone one, film C divide this zone in half allowing film A and film B to create zones one and three. First conical air chamber layout on film A of zone two (7a), zone two passageway layout on film A (6a), connecting air chamber one layout on film A (7a) and conical air chamber two layout on film A (5a) In zone two, film C divide this zone in half allowing film A and film B to create zones two and four. Entry/exit Portal Tube layout on film A (12a), controlling air flow into and out of the pad. Zone one entry/exit passageway layout on film A (14a), allowing air movement through zone one portal FIG. 15 (9). Zone two entry/exit passageway layout on film A (13a), allowing air movement through zone two portal FIG. 1 (10). Tuck-away (8), creating a pocket to secure the closed entry/exit Portal Tube FIG. 15 (12). first conical air chamber of zone one layout on film B (1b), zone one passageway FIG. 15 (2), connecting air chamber one layout in film B (1b) and conical air chamber two layout on film B (3b) In zone one, film C divide this zone in half allowing film A and film B to create zones one and three. First conical air chamber layout on film B of zone two (7b), zone two passageway layout on film B (6b), connecting air chamber one layout on film B (7b) and conical air chamber two layout on film B (5b) In zone two, film C divide this zone in half allowing film A and film B to create zones two and four. Central core film (16), that creates the passageway FIG. 15 (2), for zone one air chambers and passageway FIG. 15 (6), for zone two air chambers.

As shown in the accompanying drawing figures, the present system includes everything needed to provide a packing system that can be inflated, deflated, and reused. The packing pad of this invention is thus designed to hold and item or inner package secure in a exterior shipping carton. The packing pad may be configured, in a first embodiment in a two zone format (Side by Side zones FIG. 1, and Top to Bottom Side to Side FIG. 15) wherein the two zones are created by bonding two film sheets together (Side by Side FIG. 3 and Top to Bottom Side to Side FIG. 17) to provide air chambers for each zone, and, in a second embodiment, with a four zone design (Side by Side zones FIG. 12 and Top to Bottom Side to Side zones FIG. 25) created by heat welding three full film sheets, ((FIG. 12, FIG. 25) with the central core film (16)(21) FIG. 25, for the top to bottom side to side design (FIG. 15)) together, with the central film sheet (see (15) in FIG. 12, and, (22) in FIG. 25) creating the air chambers for each zone.

Additional security is provided by the use of a geometric, heat welded design providing controlled areas to receive impact compressed air (see FIG. 1 (1) (3) (7) (5), and FIG. 15 (1)(3) (7) (5) within the pad. Extra wide exterior seam (FIG. 1 (4)) and narrower interior field seams add pad integrity by allowing severe impact to open an interior seam moving air into adjacent zones, instead of an exterior seam rupture, allowing air to escape the pad enclosure.

Additional pad volume is provided by the layout of each geometric format, shape are placed side by side, maximizing the inflated pad surface, and providing greater depth in pad height.

Pad zones each comprise multiple interconnected air chambers to provide each pad with the maximum ability to absorb impact by distributing air to chambers not compressed by impact. The pads of the invention may be formed of any number and type of film substrates that can be welded together by, e.g., applying heat, or by an electrical or chemical bonding process. Materials useful in the formation of the films used in forming the invention are well known among those of ordinary skill in this field and the particular choice of material is not critical to the invention. Moreover, varying the film thickness provides for varying levels of pad strength and security, and can be dictated as the product to be shipped or budget require. Virtually any film that can hold air can be securely welded together can be used to create a zoned packing pad in accordance with the invention.

The air in each zone of a pad is retained by a entry/exit portal tube (see FIG. 1 (12), FIG. 15 (12)), and tuck-away film, (see FIG. 1 (8), FIG. 15 (8)), once the pad is filled with air the (see FIG. 5 and FIG. 22) the enrty/exit portal tube is folded twice over itself, (see FIG. 7, FIG. 8, FIG. 9), and then tucked under the tuck-away film (see FIG. 11 and FIG. 24) The tuck-away film is heat sealed to the front and left exterior seam, (see FIG. 1 (8), and, FIG. 15 (8)). Creating a pocket to receive the folded entry/exit portal tube (see FIG. 10).

As noted the folds in the entry/exit portal tube (see FIG. 8, FIG. 9 and FIG. 10), provide a series of locking point, adding to pad security. Deflate each pad by moving the entry/exit portal tube from the tuck-away pocket and opening the folds, deflated pads can be reused by blowing air into the entry/exit portal tube, (FIG. 1 (12), FIG. 15 (12)),and securing the folded tube in the tuck-away pocket, (FIG. 10), as described above. Interior air pressure forced against the portal area (FIG. 1 (9), (10) and FIG.>15 (9),(10)), will press the tube tighter into the tuck-away pocket (FIG. 11(8) and FIG. 24(8)), adding and additional level of security.

Type of two zone pads, are distinguished by the placement of a zones air chambers. In the side by side format, one zone controls the front and left side of the pad while the opposite zone controls the left side and back of the pad. In the top to bottom and side to side, one zone controls the front and back of the pad while the other zone controls the left and right side. The side by side is built by welding and A film and B film together with a tuck-away film welded to the left and front exterior seam. The top to bottom side to side is built welding the A film and B film to a central core film, (to create the passageways for each zone), then to each other, with a tuck-away film welded to the left and front exterior seam.

The four-zone packing pad (FIG. 12, FIG. 25) of the invention has all the features of the two-zone system, (including an additional, i.e., second central core film, (FIG. 25(21) for the top to bottom side to side pad), with the same features of air entry, locking and release in the same manner described above for the two zone pad. Additional security is offered by the four-zoned pad in that there is a central film layer (see(15) FIG. 12 and (22) FIG. 25), in each four-zone pad that divides the inflated sections into four complete zones. The interior film provides an additional area for absorbing impact. That is, when one of the exterior film areas (see FIG. 12 and FIG. 25), is subjected to impact, the resulting force can be absorbed by this soft flexible middle film layer (shown as (15) in FIG. 12 and (22) in FIG. 25).

This multi-zone feature adds a level of puncture resistance to the pad surface. That is, the use of four zones allows the pad to maintain a greater level of integrity if a zone is punctured.

It is to be understood that the present invention is not limited in scope by the exemplified embodiments which are intended as illustrations of single aspects of the invention, and the embodiments and methods which are functionally equivalent are within the scope of the invention. Indeed, various modifications of the invention in addition to those described herein will become apparent to those skilled in the art from the foregoing description.

What is claimed is:

1. An impact-resistant inflatable reusable two zoned packing pad for protecting articles during shipping from shock and damage, said packing pad comprising first and second outer film layers, said first and second film layers being secured together along an outer perimeter thereof to define an inner volume within said pad and, said first and said second film layers within said inner volume in a location selected to form at least two separate zones within said inner pad volume, said pad further comprising at least one entry/exit portal tube passageway for each separate zone within said pad, said pad further comprising said entry/exit portal tube passageway for each separate zone configured and adapted to permit repeated independent inflation and deflation of each said zone.

2. The system of claim 1, wherein each said zone is comprised of a plurality of inflatable chambers configured and adapted to redistribute an inflation gas contained therein from one or more chambers compressed by and external impact to at least one contiguous chamber which is not impacted.

3. The system of claim 2, wherein said chambers maximize available pad surface area and are substantially conical in shape.

4. An impact-resistant inflatable reusable four zoned packing pad for protecting articles during shipping from shock and damage, said packing pad comprising first and second outer film layers with a complete central film layer, said first and second film layers being secured to the central film layer along an outer perimeter thereof to define an inner volume within said pad and, said first and said second film layers within said inner volume in a location selected to form at least four separate zones within said inner pad volume, said pad further comprising at least one entry/exit portal tube passageway for each separate zone within said pad, said pad further comprising said entry/exit portal tube passageway for each separate zone configured and adapted to permit repeated independent inflation and deflation of each said zone.
